(19) United States
(12) Patent Application Publication
(10) Pub. No.: US 2026/0331483 A1
(43) Pub. Date: Oct. 22, 2026

(54) LITHIUM NICKEL OXIDE CATHODE MATERIAL AND PREPARATION METHOD THEREFORE AND USE THEREOF

(71) Applicant: NINGBO ZHILIANG NEW ENERGY CO., LTD., Ningbo, Zhejiang (CN)

(72) Inventor: Linsen LI, Ningbo, Zhejiang (CN)

(21) Appl. No.: 18/993,317

(22) PCT Filed: Sep. 5, 2023
(86) PCT No.: PCT/CN2023/116925

§ 371 Date: Jan. 10, 2025

(30) Foreign Application Priority Data
Jul. 12, 2022 (CN) 202210816136.4

(51) Int. Cl. H01M 4/525; C01G 53/42; H01M 4/02; H01M 10/0525

(52) U.S. Cl. CPC H01M 4/525; C01G 53/42; H01M 10/0525; C01P 2002/76; C01P 2004/04; C01P 2006/40; H01M 2004/028

(57) ABSTRACT

A lithium nickel oxide cathode material, a preparation method therefore and use thereof is provided. The cathode material has a chemical formula of Li₁₊ₓNi₁₋ₓO₂, wherein 0.025≤x≤0.08; a crystal structure is an α-NaFeO₂ type hexagonal layered structure with a space group of R-3m. Li that is surplus to the stoichiometric ratio of Ni occupies octahedral voids in a Ni layer and is randomly distributed in the octahedral voids. The preparation method includes the following steps: (1) reacting a nickel source and a lithium source with oxygen in the presence of a molten salt additive to obtain a product comprising lithium nickel oxide; and (2) purifying the product comprising lithium nickel oxide to obtain a powder comprising lithium nickel oxide, and placing the powder in an oxygen environment to obtain the lithium nickel oxide cathode material. The cathode material has high energy density, excellent cycle stability and excellent thermal stability.

### CROSS-REFERENCE TO RELATED APPLICATIONS

This application is a national Stage of PCT/CN2023/116925, having a filing date of Sep. 5, 2023, which claims priority to Chinese Application No. 202210816136.4, having a filing date of Jul. 12, 2022, the contents of both of which are incorporated by reference in their entirety.

### FIELD OF TECHNOLOGY

The following relates to the technical field of lithium-ion batteries and, in particular, relates to a lithium nickel oxide cathode material and a preparation method therefor and use thereof.

### BACKGROUND

Ternary materials represented by lithium nickel cobalt manganese oxide and lithium nickel cobalt aluminum oxide can provide good energy density and power density and have been widely used in the manufacture of power batteries. By increasing the nickel content, the energy density of ternary cathode materials can be increased, but it will reduce the cycle stability and thermal stability of the materials. Lithium nickel oxide (LiNiO₂) has a high energy density (>900 Wh/kg at the material level), but it is not easy to obtain a phase that conforms to the theoretical stoichiometric ratio during synthesis of this type of material, and the material is usually lithium-deficient (the molar ratio of Li to Ni is less than 1). During the electrochemical cycle, the material is prone to structural transformation from a layered phase to a rock salt phase, and is also prone to loss of lattice oxygen, resulting in poor cycle stability. The structural transformation also leads to poor rate performance. In order to improve the energy density, the prior art provides a variety of lithium-rich cathode materials (usually the molar ratio of Li to a transition metal is greater than 1.1:0.9). However, the traditional lithium-rich cathode materials are composed of two structural units, namely structural units R-3m (layered structure LiMO₂, M=Ni, Co, Mn and other transition metals) and c/2m (monoclinic structure Li₂MO₃, M=Mn, Co, or Ni). However, materials containing the unit c/2m (Li₂MO₃ unit, M=Mn, Co or Ni) need to be charged to a high voltage (>4.5 V vs Li⁺/Li) due to their thermodynamic properties, so as to deintercalate more lithium ions and achieve a high energy density. Such a high voltage exceeds the stability window of the electrolyte, resulting in poor interface stability of the materials and affecting the cycle life of the materials. That is, it is difficult for the cathode materials in the prior art to achieve high energy density and excellent cycle stability and thermal stability.

### SUMMARY

An aspect relates to a lithium nickel oxide cathode material, and when the lithium nickel oxide cathode material is used in a lithium-ion battery, the lithium-ion battery has high energy density, excellent cycle stability and excellent thermal stability.

In order to solve the above technical problems, a technical solution adopted by embodiments of the invention is as follows:
A lithium nickel oxide cathode material having a chemical formula of Li₁₊ₓNi₁₋ₓO₂, wherein 0.02≤x≤0.08; a crystal structure of the lithium nickel oxide cathode material is an α-NaFeO₂ type hexagonal layered structure, and the crystal structure of the lithium nickel oxide cathode material has a space group of R-3m; in the crystal structure of the lithium nickel oxide cathode material, Li that is surplus to the stoichiometric ratio of Ni occupies octahedral voids in a Ni layer in the layered structure and is randomly distributed in the octahedral voids.

The molar ratio of Li to Ni in the lithium nickel oxide cathode material described above is slightly greater than 1:1, and the cathode material is in a slightly lithium-rich state.

In embodiments, 0.03≤x≤0.06.

In embodiments, 0.04≤x≤0.05.

In embodiments, by neutron diffraction detection, no Li₂NiO₃ unit with a space group of c/2m is detected in the crystal structure.

An aspect of embodiments of the present invention further provides a lithium nickel oxide cathode material having a chemical formula of Li₁₊ₓNi₁₋ₓO₂, wherein 0.02≤x≤0.08; a crystal structure of the lithium nickel oxide cathode material is an α-NaFeO₂ type hexagonal layered structure, and the crystal structure has a space group of R-3m.

In embodiments, 0.03≤x≤0.06.

In embodiments, 0.04≤x≤0.05.

In embodiments, in the crystal structure of the lithium nickel oxide cathode material, Li that is surplus to the stoichiometric ratio of Ni occupies octahedral voids in a Ni layer in the layered structure and is randomly distributed in the octahedral voids.

In embodiments, by neutron diffraction detection, no Li₂NiO₃ unit with a space group of c/2m is detected in the crystal structure.

In embodiments, when the neutron diffraction test is performed for characterization, no superstructure peak is observed, that is, no Li₂NiO₃ unit with a space group of c/2m is detected, so it can be determined that the crystal structure of the lithium nickel oxide cathode material does not contain a Li₂NiO₃ unit with a space group of c/2m.

An aspect of embodiments of the present invention further provides a lithium nickel oxide cathode material having a chemical formula of Li₁₊ₓNi₁₋ₓO₂, wherein 0.025≤x≤0.08, and the lithium nickel oxide cathode material is prepared by a preparation method including the following steps: (1) reacting a nickel source and a lithium source with oxygen in the presence of a molten salt additive to obtain a product comprising lithium nickel oxide; and (2) purifying the product comprising lithium nickel oxide to obtain a powder comprising lithium nickel oxide, and placing the powder in an oxygen environment to obtain the lithium nickel oxide cathode material.

In embodiments, the molten salt additive refers to an additive that can form a eutectic mixture with a lower eutectic point with the lithium source in the reaction raw materials. The molten salt additive may be a Li-containing molten salt or a Li-free molten salt.

An aspect of embodiments of the present invention further provides a preparation method for the described lithium nickel oxide cathode material, which can stably prepare a slightly lithium-rich lithium nickel oxide cathode material. The preparation method includes the following steps:
(1) reacting a nickel source and a lithium source with oxygen in the presence of a molten salt additive to obtain a product comprising lithium nickel oxide; and
(2) purifying the product comprising lithium nickel oxide to obtain a powder comprising lithium nickel oxide and placing the powder in an oxygen environment to obtain the lithium nickel oxide cathode material.

The product comprising lithium nickel oxide obtained in step (1) generally contains an excess of lithium source and molten salt additive in addition to lithium nickel oxide.

The purification step in step (2) can remove the excess lithium source and molten salt additive, but this process may cause damage to the surface structure of lithium nickel oxide. Placing the powder in an oxygen environment in step (2) can repair the surface structure of lithium nickel oxide, so that the crystal structure of the final lithium nickel oxide cathode material has a perfect layered structure with a space group of only R-3m.

In embodiments, the nickel source is selected from the group consisting of NiO, Ni(OH)₂, NiCO₃ and a combination thereof.

In embodiments, the lithium source is LiOH or LiOH·H₂O.

The molten salt additive is selected from the group consisting of Li₂SO₄, Na₂SO₄, K₂SO₄ and a combination thereof.

In embodiments, the molten salt additive is Li₂SO₄.

In embodiments, the molar ratio of the lithium source to the nickel source is 1.1-1.7:1. In embodiments, the molar ratio of the lithium source to the nickel source is 1.3-1.5:1.

In embodiments, the molar ratio of the molten salt additive to the nickel source is 0.1-0.5:1.

In embodiments, the molar ratio of the molten salt additive to the nickel source is 0.27-0.5:1.

In embodiments, in step (1), the reaction is carried out at a temperature of 550° C.-650° C.

In embodiments, in step (1), the reaction is carried out for 10-20 h.

In embodiments, in step (2), the oxygen environment has a temperature of 450° C.-550° C.

In embodiments, in step (2), the powder is placed in an oxygen environment for 2-5 h.

In embodiments, in step (2), the purification includes water washing and filtering.

In embodiments, the method further includes a step of crushing the product comprising lithium nickel oxide prior to the purification.

In embodiments, the method includes the following steps:
(1) well mixing a nickel source, a lithium source and a molten salt additive to obtain a mixture, placing the mixture in a reactor, introducing oxygen into the reactor, and heating the mixture for reaction to obtain a product comprising lithium nickel oxide; and
(2) crushing the product comprising lithium nickel oxide, washing with water, filtering to obtain a powder comprising lithium nickel oxide, placing the powder in a reactor, introducing oxygen into the reactor, and heating to obtain the lithium nickel oxide cathode material. The water washing can remove the excess lithium source and molten salt additive.

In embodiments, in step (1), the oxygen is introduced at a rate of 0.1-0.5 L/min.

In embodiments, in step (1), the heating rate is 2-10° C./min.

In embodiments, in step (1), the reaction is followed by cooling, the cooling rate is 2-10° C./min.

In embodiments, in step (2), the oxygen is introduced at a rate of 0.1-0.5 L/min.

In embodiments, in step (2), the heating rate is 2-10° C./min.

In embodiments, in step (2), the heating is followed by cooling, the cooling rate is 2-10° C./min.

In embodiments, the reactor is a tube furnace.

An aspect of embodiments of the present invention further provides a use of the described lithium nickel oxide cathode material in a lithium-ion battery.

An aspect of embodiments of the present invention further provides a lithium-ion battery, comprising a cathode, wherein the cathode comprises the lithium nickel oxide cathode material described above. In embodiments, the first discharge energy density of the lithium-ion battery at a rate of 0.1 C is greater than or equal to 904 Wh/kg.

In embodiments, after 100 charge-discharge cycles in a voltage range of 4.3-2.8 V at a rate of 1 C, the discharge specific capacity retention rate of the lithium-ion battery is greater than or equal to 92.3%.

In embodiments, the thermal runaway temperature T2 of the lithium-ion battery (the temperature at which the self-heating temperature rise is greater than 1° C./min) is greater than or equal to 253.2° C.

Compared with the prior art, embodiments of the invention the following technical advantages:

The lithium nickel oxide (LiNiO₂) cathode material of embodiments of the invention have a thermodynamically stable α-NaFeO₂ type hexagonal layered structure, and its crystal structure has a space group of R-3m. The cathode material of embodiments of the invention do not contain the Li₂NiO₃ unit with a space group of c/2m, thereby overcoming the defect that conventional cathode materials cannot achieve both excellent cycle stability and high-rate performance. The lithium nickel oxide cathode material of embodiments of the invention have high cycle stability, high-rate performance and high thermal stability.

An aspect of embodiments of the present invention introduces a slightly excess of lithium ions in a stoichiometric ratio into the nickel layer in the layered structure of lithium nickel oxide by molten salt chemistry and obtains a slightly lithium-rich lithium nickel oxide cathode material without changing the layered crystal structure. When the cathode material is applied to the cathode of a lithium-ion battery, the lithium-ion battery can achieve an energy density of >900 Wh/kg and has excellent cycle stability and rate performance after being charged to 4.3 V (vs Li⁺/Li).

### BRIEF DESCRIPTION

Some of the embodiments will be described in detail, with references to the following Figures, wherein like designations denote like members, wherein:

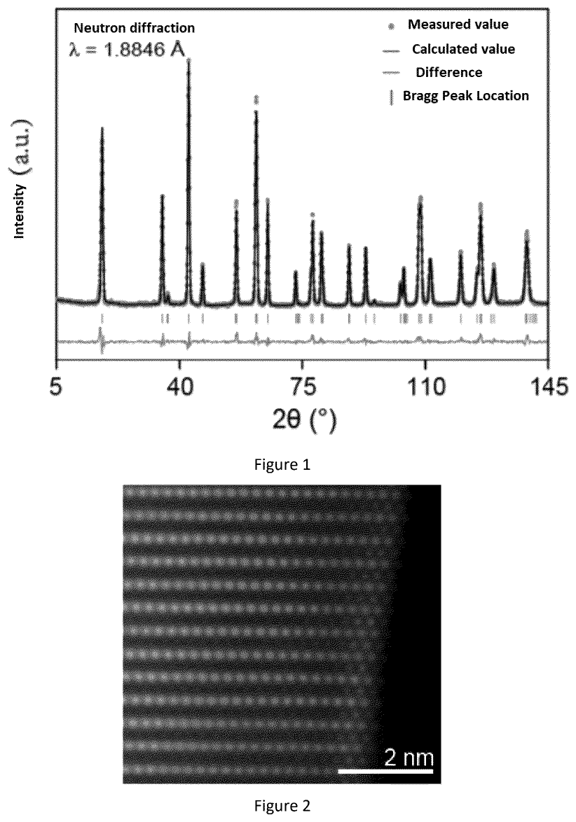

FIG. 1 shows neutron diffraction test results of a cathode material 1 in Example 1;

FIG. 2 shows a scanning/transmission electron microscopy image of cathode material 1 in Example 1;

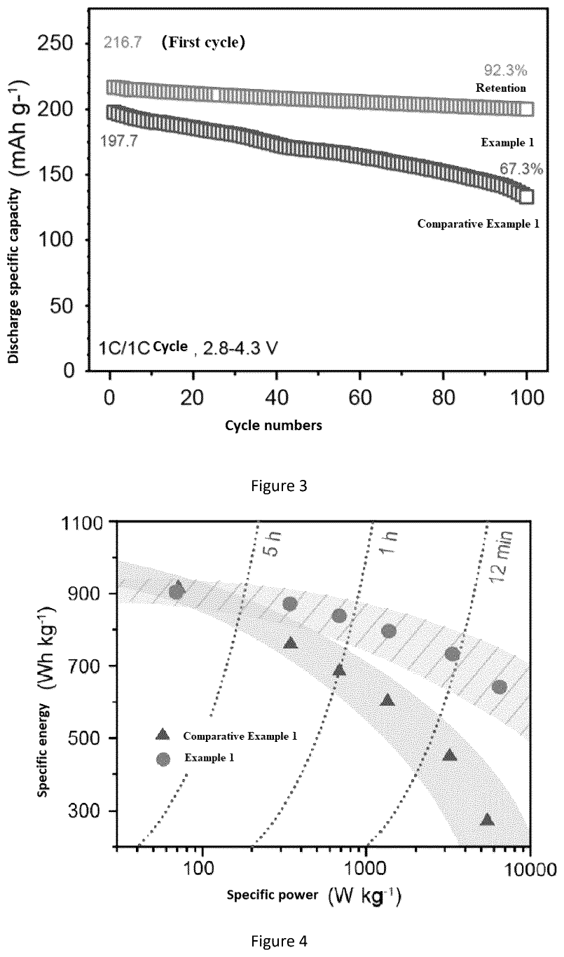

FIG. 3 shows electrochemical charge and discharge test results of cathode material 1 in Example 1 and comparative cathode material 1 in Comparative Example 1;

FIG. 4 shows rate test results of cathode material 1 in Example 1 and comparative cathode material 1 in Comparative Example 1;

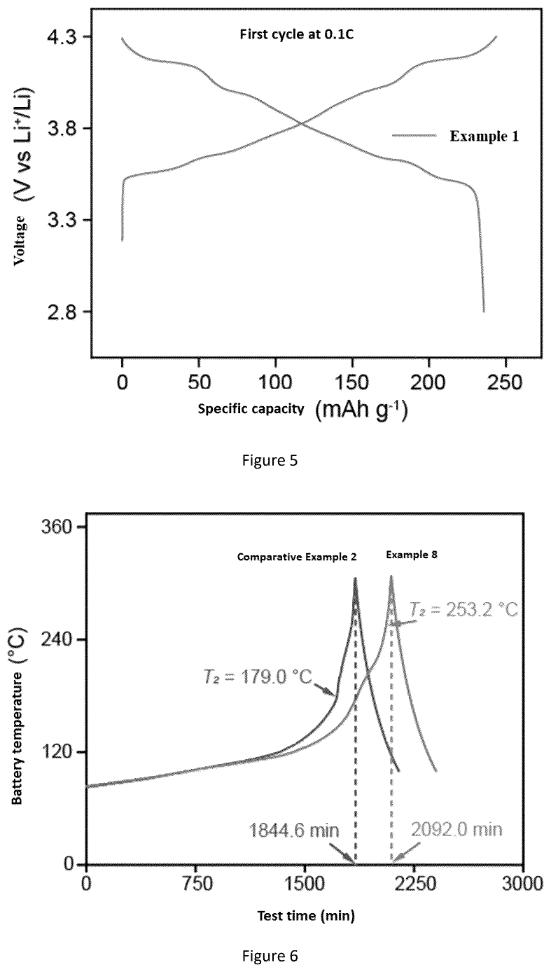

FIG. 5 shows first charge and discharge curves of cathode material 1 in Example 1;

FIG. 6 shows thermal safety test results of cathode material 1 in Example 1 and comparative cathode material 1 in Comparative Example 1 in a charged state;

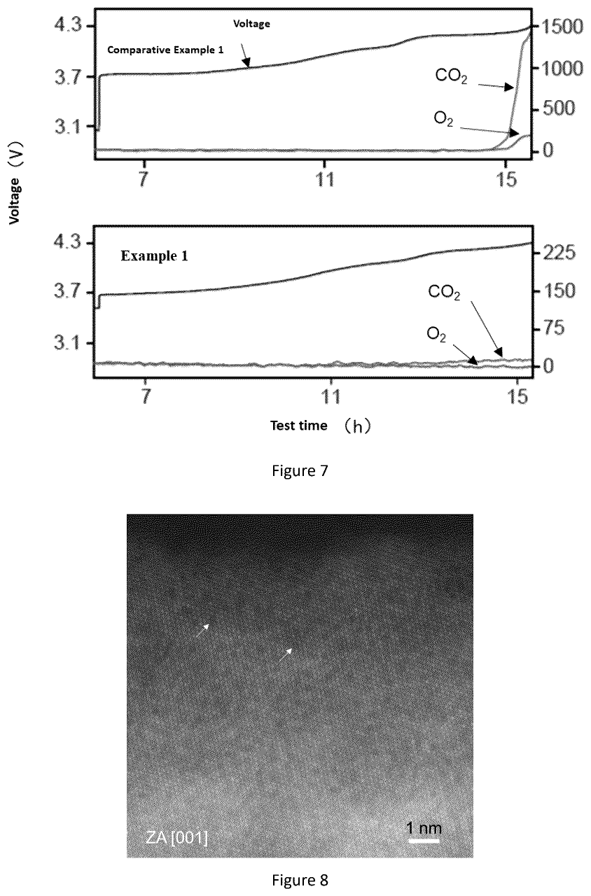

FIG. 7 shows oxygen release test results of cathode material 1 in Example 1 and a conventional lithium-deficient lithium nickel oxide in the prior art;

FIG. 8 shows a scanning/transmission electron microscopy image of cathode material 1 in Example 1; and

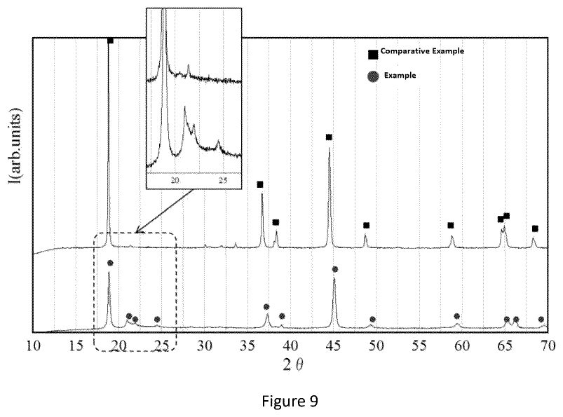

FIG. 9 shows a neutron diffraction pattern of a cathode material in Comparative Example 6.

### DETAILED DESCRIPTION

Although lithium nickel oxide (LiNiO₂) has a high energy density (>900 Wh/kg), it is not easy to obtain a phase that conforms to the theoretical stoichiometric ratio during synthesis of this type of material, and the material is usually lithium-deficient (the molar ratio of Li to Ni is less than 1). During the electrochemical cycle, the material is prone to structural transformation from a layered phase to a rock salt phase, and is also prone to loss of lattice oxygen, resulting in poor cycle stability. The structural transformation also leads to poor rate performance.

Conventional lithium nickel oxide is usually prepared by solid-state reaction, and the obtained lithium nickel oxide is lithium-deficient and has a chemical formula of Li_{1-y}Ni_{1+y}O₂. In order to improve the performance of the lithium nickel oxide, the structure of the lithium nickel oxide is usually modified by lattice doping or surface coating.

The slightly lithium-rich lithium nickel oxide cathode material having a chemical formula of Li₁₊ₓNi₁₋ₓO₂ cannot be prepared by a conventional solid-state reaction preparation method. Although the phase of the material is predicted to be a possible phase according to a Li—Ni—O phase diagram, the material cannot be truly prepared by experiment.

Although there are other types of lithium-rich cathode materials in the prior art and the molar ratio of Li to a transition metal in such materials is usually greater than 1.1:0.9, in the crystal structure of such materials, in addition to the structural unit R-3m in the layered structure, there is also the structural unit c/2m (monoclinic structure Li₂NiO₃), resulting in such materials being able to achieve high energy density under a high voltage, but having poor cycle stability.

An aspect of embodiments of the present invention creatively uses molten salt chemistry to add a molten salt additive when synthesizing lithium nickel oxide, so as to prepare a slightly lithium-rich lithium nickel oxide cathode material having a layered structure which only contains the structural unit R-3m, the chemical formula of the cathode material being Li₁₊ₓNi₁₋ₓO₂. When the cathode material is used in a lithium-ion batteries, the lithium-ion batteries have high energy density, excellent cycle stability and excellent thermal stability.

### Example 1

Ni(OH)₂, LiOH and Li₂SO₄ were well mixed at a molar ratio of 1:1.3:0.27 to obtain a mixed powder, and the mixed powder was contained in a corundum boat and heated in a tube furnace, where pure oxygen was introduced at a rate of 0.2 L/min and the powder was heated up to 600° C. at a rate of 5° C./min, and after being held at 600° C. for 15 h, the mixed powder was cooled to room temperature at a rate of 5° C./min.

The cooled powder was taken out and mechanically crushed, and deionized water was added to dissolve the excess LiOH and Li₂SO₄. The solid product was filtered out and dried at 60° C. with air blowing. The dried powder was contained in a corundum boat again and heated in the tube furnace, where pure oxygen was introduced at a rate of 0.2 L/min and the powder was heated up to 500° C. at a rate of 5° C./min, and after being held at 500° C. for 5 h, the powder was cooled to room temperature at a rate of 5° C./min, thus obtaining cathode material 1.

The crystal structure of the cathode material 1 was characterized by neutron diffraction (FIG. 1), and it was confirmed that cathode material 1 had a layered structure with a space group of R-3m but did not contain a Li₂NiO₃ unit with a space group of c/2m because no superstructure peaks were observed, where the superstructure refers to an in-plane superstructure caused by the orderly arrangement of Li@Ni6 (formed by Li and Ni) in the Ni layer, and the superstructure corresponds to the Li₂NiO₃ unit of c/2m symmetry. It was further confirmed by scanning/transmission electron microscopy that the excess Li ions were randomly distributed in the Ni layer. The results of scanning/transmission electron microscopy are shown in FIG. 8. Since Li is lighter than Ni, its contrast is darker. It can be seen from FIG. 8 that the darker points correspond to the presence of Li atoms that replace Ni in the Ni layer and are randomly distributed (as indicated by the arrows in FIG. 8). It was also confirmed by scanning/transmission electron microscopy that the material had a layered structure (FIG. 2). The elemental composition of the material was analyzed by ICP, and it was confirmed that the molar ratio of Li to Ni was 1.04:0.96 (i.e., in the chemical formula Li₁₊ₓNi₁₋ₓO₂, x=0.04). The results are shown in Table 1.

### Example 2

Ni(OH)₂, LiOH and Li₂SO₄ were well mixed at a molar ratio of 1:1.1:0.27 to obtain a mixed powder, and the mixed powder was contained in a corundum boat and heated in a tube furnace, where pure oxygen was introduced at a rate of 0.5 L/min and the powder was heated up to 650° C. at a rate of 2° C./min, and after being held at 650° C. for 15 h, the mixed powder was cooled to room temperature at a rate of 2° C./min. The cooled powder was taken out and mechanically crushed, and deionized water was added to dissolve the excess LiOH and Li₂SO₄. The solid product was filtered out and dried at 60° C. with air blowing. The dried powder was contained in a corundum boat again and heated in the tube furnace, where pure oxygen was introduced at a rate of 0.5 L/min and the powder was heated up to 450° C. at a rate of 2° C./min, and after being held at 450° C. for 2 h, the powder was cooled to room temperature at a rate of 2° C./min, thus obtaining cathode material 2. The elemental composition of the material was analyzed by ICP and the results are shown in Table 1.

### Example 3

Ni(OH)₂, LiOH and Li₂SO₄ were well mixed at a molar ratio of 1:1.7:0.27 to obtain a mixed powder, and the mixed powder was contained in a corundum boat and heated in a tube furnace, where pure oxygen was introduced at a rate of 0.1 L/min and the powder was heated up to 550° C. at a rate of 10° C./min, and after being held at 550° C. for 15 h, the mixed powder was cooled to room temperature at a rate of 10° C./min.

The cooled powder was taken out and mechanically crushed, and deionized water was added to dissolve the excess LiOH and Li₂SO₄. The solid product was filtered out and dried at 60° C. with air blowing. The dried powder was contained in a corundum boat again and heated in the tube furnace, where pure oxygen was introduced at a rate of 0.1 L/min and the powder was heated up to 550° C. at a rate of 10° C./min, and after being held at 550° C. for 4 h, the powder was cooled to room temperature at a rate of 10° C./min, thus obtaining cathode material 3. The elemental composition of the material was analyzed by ICP and the results are shown in Table 1.

### Example 4

Ni(OH)₂, LiOH and Li₂SO₄ were well mixed at a molar ratio of 1:1.5:0.1 to obtain a mixed powder, and the mixed powder was contained in a corundum boat and heated in a tube furnace, where pure oxygen was introduced at a rate of 0.2 L/min and the powder was heated up to 600° C. at a rate of 5° C./min, and after being held at 600° C. for 15 h, the mixed powder was cooled to room temperature at a rate of 5° C./min.

The cooled powder was taken out and mechanically crushed, and deionized water was added to dissolve the excess LiOH and Li₂SO₄. The solid product was filtered out and dried at 60° C. with air blowing. The dried powder was contained in a corundum boat again and heated in the tube furnace, where pure oxygen was introduced at a rate of 0.2 L/min and the powder was heated up to 500° C. at a rate of 5° C./min, and after being held at 500° C. for 5 h, the powder was cooled to room temperature at a rate of 5° C./min, thus obtaining cathode material 4. The elemental composition of the material was analyzed by ICP and the results are shown in Table 1.

### Example 5

Ni(OH)₂, LiOH and Li₂SO₄ were well mixed at a molar ratio of 1:1.5:0.5 to obtain a mixed powder, and the mixed powder was contained in a corundum boat and heated in a tube furnace, where pure oxygen was introduced at a rate of 0.2 L/min and the powder was heated up to 600° C. at a rate of 5° C./min, and after being held at 600° C. for 15 h, the mixed powder was cooled to room temperature at a rate of 5° C./min.

The cooled powder was taken out and mechanically crushed, and deionized water was added to dissolve the excess LiOH and Li₂SO₄. The solid product was filtered out and dried at 60° C. with air blowing. The dried powder was contained in a corundum boat again and heated in the tube furnace, where pure oxygen was introduced at a rate of 0.2 L/min and the powder was heated up to 500° C. at a rate of 5° C./min, and after being held at 500° C. for 5 h, the powder was cooled to room temperature at a rate of 5° C./min, thus obtaining cathode material 5. The elemental composition of the material was analyzed by ICP and the results are shown in Table 1.

### Example 6

NiO, LiOH·H₂O and Li₂SO₄ were well mixed at a molar ratio of 1:1.3:0.27 to obtain a mixed powder, and the mixed powder was contained in a corundum boat and heated in a tube furnace, where pure oxygen was introduced at a rate of 0.2 L/min and the powder was heated up to 600° C. at a rate of 5° C./min, and after being held at 600° C. for 15 h, the mixed powder was cooled to room temperature at a rate of 5° C./min.

The cooled powder was taken out and mechanically crushed, and deionized water was added to dissolve the excess LiOH·H₂O and Li₂SO₄. The solid product was filtered out and dried at 60° C. with air blowing. The dried powder was contained in a corundum boat again and heated in the tube furnace, where pure oxygen was introduced at a rate of 0.2 L/min and the powder was heated up to 500° C. at a rate of 5° C./min, and after being held at 500° C. for 5 h, the powder was cooled to room temperature at a rate of 5° C./min, thus obtaining cathode material 6. The elemental composition of the material was analyzed by ICP and the results are shown in Table 1.

### Example 7

NiCO₃, LiOH and Li₂SO₄ were well mixed at a molar ratio of 1:1.3:0.27 to obtain a mixed powder, and the mixed powder was contained in a corundum boat and heated in a tube furnace, where pure oxygen was introduced at a rate of 0.2 L/min and the powder was heated up to 600° C. at a rate of 5° C./min, and after being held at 600° C. for 15 h, the mixed powder was cooled to room temperature at a rate of 5° C./min.

The cooled powder was taken out and mechanically crushed, and deionized water was added to dissolve the excess LiOH and Li₂SO₄. The solid product was filtered out and dried at 60° C. with air blowing. The dried powder was contained in a corundum boat again and heated in the tube furnace, where pure oxygen was introduced at a rate of 0.2 L/min and the powder was heated up to 500° C. at a rate of 5° C./min, and after being held at 500° C. for 5 h, the powder was cooled to room temperature at a rate of 5° C./min, thus obtaining cathode material 7. The elemental composition of the material was analyzed by ICP and the results are shown in Table 1.

### Comparative Example 1

Ni(OH)₂ and LiOH were well mixed at a molar ratio of 1:1.02 to obtain a mixed powder, and the mixed powder was contained in a corundum boat and heated in a tube furnace, where pure oxygen was introduced at a rate of 0.2 L/min and the powder was heated up to 485° C. at a rate of 5° C./min and held at 485° C. for 3 h, and then further heated up to 700° C. and held at 700° C. for 20 h, and then cooled to room temperature at a rate of 5° C./min, thus obtain comparative cathode material 1. The elemental composition of the material was analyzed by ICP and the results are shown in Table 1.

### Performance Test:

Electrochemical cycle stability: The cathode material 1 of Example 1 was assembled into a button battery with a lithium sheet, a separator and an electrolyte (a solution of lithium hexafluorophosphate dissolved in dimethyl carbonate and fluoroethylene carbonate at a volume ratio of 1:1, and the concentration of lithium hexafluorophosphate was 1 mol/L) in an argon-protected glove box, and charged and discharged within a voltage range of 4.3-2.8V at a rate of 1 C. The comparative cathode material 1 of Comparative Example 1 was subjected to the same operation, and the electrochemical cycle stability results tested are shown in FIG. 3.

Rate performance: The same button battery as above was used to evaluate the rate performance of the two materials. After being charged to 4.3 V at a rate of 0.2 C, the cathode material was discharged at a rate of 0.5 C to 10 C. The test results are shown in FIG. 4. The first discharge energy density of the button battery corresponding to the cathode material 1 of Example 1 was 904 Wh/kg, obtained by integrating the charge and discharge curves (FIG. 5).

### Example 8 (Thermal Safety Test)

The cathode material 1 of Example 1 was used to assemble a pouch battery for thermal safety evaluation. The assembly method was implemented as follows: (1) Preparation of cathode plate: an active material (cathode material 1 of Example 1), a conductive agent (carbon black) and a binder (5 wt % polyvinylidene fluoride/N-methylpyrrolidone solution) were mixed at a mass ratio of 94:3:3, N-methylpyrrolidone (NMP) was added to adjust the solid content to 65%, the resulting mixture was applied to a 13 μm aluminum foil and dried, and the aluminum foil was punched by a punching machine to obtain a 55 mm*35 mm (H*W) cathode plate; the cathode plate was then rolled and vacuum-dried at 120° C. for 12 h. (2) Preparation of anode plate: an active material (graphite), a conductive agent (carbon black) and a binder (5 wt % polyvinylidene fluoride/N-methylpyrrolidone solution) were mixed at a mass ratio of 94:3:3, NMP was added to adjust the solid content to 45%, and the resulting mixture was applied to a 10 μm copper foil and dried, and the copper foil was punched by a punching machine to obtain a 57 mm*37 mm (H*W) anode plate; and the anode plate was then rolled and vacuum-dried at 80° C. for 12 h. (3) Production of pouch battery: a 16 μm PE separator, the cathode plate and the anode plate were stacked to form a battery cell, ensuring that each cathode had a corresponding anode. The outermost layer was wrapped with the separator and then sealed with a polyimide tape. An ultrasonic welding machine was used to weld aluminum and nickel tabs to exposed tabs of the cathode and the anode, respectively. The welds were sealed with a polyimide tape. The outer layer of the battery cell was wrapped with an aluminum plastic film and an opening was left for filling an electrolyte. The prepared battery cell was vacuum-dried at 60° C. for 6 h. The capacity of the battery cell was set to 30 mAh. (4) Battery preparation: 0.5 g of electrolyte (the composition of the electrolyte was a 1.2 M lithium hexafluorophosphate solution, the solvent was a mixed solvent of ethylene carbonate EC and ethyl methyl carbonate EMC at a weight ratio of 3:7, and the solvent contained 2%, by mass, of vinylene carbonate VC) was filled into the battery cell with a pipette, and the electrolyte filling opening was sealed with a sealing machine. The battery cell was placed flat and left to stand for 10 h before testing. (5) Battery formation and testing: the battery was clamped with a fixture and then tested on a charge-discharge tester: the battery was CC (constant current) charged at 0.1 C (22 mA/g, based on the mass of the cathode active material, the same below) to 4.25 V and CV (constant voltage) charged to 0.05 C. The battery was discharged at 0.1 C to 2.75 V. The above steps were repeated 3 times, and the battery formation was completed.

In embodiments, the method for thermal safety evaluation was implemented as follows: two prepared pouch batteries were respectively CC charged at 0.1 C to 4.25 V, and CV charged to 0.05 C for later use. The cavity of the accelerated rate calorimeter was opened, the front end of the thermocouple was adhered to the center of a battery with an aluminum tape, the other battery was stacked, and the two batteries were sticked together with an aluminum tape and fixed on a special test jig in the cavity. The accelerated rate calorimeter was capped, and the accelerated rate calorimeter program was started for testing. Specific test process: the process starts the test from 25° C. and first enters the heating mode to heat the cavity at a rate of 5° C. each time (10 minutes) and monitors the battery temperature. Then, let the batteries stand for 30 min and the process enters a search mode. During this period, if the temperature rise rate is lower than 0.02° C./min, the process continues heating after the standing ends. If the temperature rise rate is higher than 0.02° C./min, the process enters a heat release mode, no longer heats the cavity, and only records the temperature change. After the temperature exceeds 300° C., the process enters a cooling mode and completes the test. The test results are shown in FIG. 6. The battery provided with the cathode material 1 of Example 1 has a relatively high T2 temperature (thermal runaway temperature, the temperature at which the self-heating temperature rise is greater than 1° C./min), which is 253.2° C.

### Comparative Example 2 (Thermal Safety Test)

The assembly method and thermal safety evaluation method of the pouch battery was the same as those of Example 8, except that the cathode material 1 of Example 1 was replaced by the comparative cathode material 1 of Comparative Example 1. The test results are shown in FIG. 6, and the T2 temperature (thermal runaway temperature, the temperature at which the self-heating temperature rise is greater than 1° C./min) of the pouch battery is 179.0° C. Therefore, Comparative Example 2 is more prone to thermal runaway than Example 8.

The in-situ differential electrochemical mass spectrometry DEMS was performed to test the release of oxygen and carbon dioxide on the lithium nickel oxide cathode material of Example 1 and the conventional lithium-deficient lithium nickel oxide cathode material in the prior art. The test conditions were the first charge, and the charging rate was 0.1 C. The results are shown in FIG. 7, where A is conventional lithium nickel oxide (LNO), and B is the lithium nickel oxide (slightly lithium-rich LR-LNO) of Example 1. It can be seen that in the conventional LNO, the releases of O₂ and CO₂ are 4.2 μmol/g and 86.5 μmol/g, respectively, during lithium removal, while the slightly lithium-rich LR-LNO of Example 1 basically does not release O₂.

### Example 9

This example is almost the same as Example 1 except that Li₂SO₄ was replaced by Na₂SO₄.

### Example 10

This example is almost the same as Example 1 except that Li₂SO₄ was replaced by K₂SO₄.

### Comparative Example 3

This example is almost the same as Example 1 except that no Li₂SO₄ was added.

### Comparative Example 4

This example is almost the same as Example 1 except that the molar ratio of Ni(OH)₂ to LiOH to Li₂SO₄ was 1:1.05:0.27.

### Comparative Example 5

This example is almost the same as Example 1 except that the molar ratio of Ni(OH)₂ to LiOH to Li₂SO₄ was 1:2:0.27.

### Comparative Example 6

The solution of an embodiment in JP2015082345A is as follows:

Lithium peroxide (Li₂O₂) and nano-sized nickel oxide were used as starting materials, crushed and mixed at a molar ratio of Li/Ni being 1.9; the mixture was filled into a platinum tank, and the raw material mixture was sintered at 700° C. for 1 h at a pressure of 4 GPa using a cubic anvil high-pressure device to obtain a lithium-rich lithium nickel oxide. The average particle size of the lithium-rich lithium nickel oxide was about 50-100 nm, and the amount of each element was analyzed by ICP-AES (atomic emission spectroscopy), and it was confirmed that the composition of the lithium-rich lithium nickel oxide was Li_{1.30}Ni_{0.70}O₂. FIG. 2 (neutron diffraction pattern) of this patent is shown in FIG. 9. It can be seen that the cathode material has a layered structure. In addition to R-3m, the space group also contains a Li₂NiO₃ unit with a space group of c/2m, because there is a very obvious superstructure peak in FIG. 9 (2θ is in the range of 20-25 degrees, indicated by the dotted box), corresponding to the Li₂NiO₃ unit with a space group of c/2m (here, M=Ni), namely, the orderly arrangement of Li@Ni6 in the Ni layer.

The elemental composition of the materials of Examples 9-10 and Comparative Examples 3-5 was analyzed by ICP, and the results are shown in Table 1.

TABLE 1
Elemental analysis results of examples and comparative examples

| | | | Capacity retention after |
|---|---|---|---|
| | Molar ratio | Value of x in | 100 charge-discharge |
| | of Li to Ni | Li₁₊ₓNi₁₋ₓO₂ | cycles at 1 C (%) |
| Example 1 | 1.04:0.96 | 0.04 | 92.3 |
| Example 2 | 1.02:0.98 | 0.02 | 90.5 |
| Example 3 | 1.08:0.92 | 0.08 | 91.0 |
| Example 4 | 1.06:0.94 | 0.06 | 91.4 |
| Example 5 | 1.05:0.95 | 0.05 | 91.5 |
| Example 6 | 1.03:0.97 | 0.03 | 92.0 |
| Example 7 | 1.04:0.97 | 0.04 | 91.8 |
| Comparative | 0.98:1.02 | −0.02 | 67.3 |
| Example 1 | | | |
| Example 9 | 1.035:0.965 | 0.035 | 90.7 |
| Example 10 | 1.032:0.968 | 0.032 | 90.1 |
| Comparative | 1.01:0.99 | 0.01 | 65.2 |
| Example 3 | | | |
| Comparative | 0.99:1.01 | −0.01 | 64.7 |
| Example 4 | | | |
| Comparative | 1.15:0.85 | 0.15 | 78.2 |
| Example 5 | | | |

Although the present invention has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. (canceled)

2. (canceled)

3. (canceled)

4. A lithium nickel oxide cathode material, wherein, the lithium nickel oxide cathode material has a chemical formula of Li₁₊ₓNi₁₋ₓO₂, wherein 0.025≤x≤0.08; a crystal structure of the lithium nickel oxide cathode material is an α-NaFeO₂ type hexagonal layered structure, and the crystal structure has a space group of R-3m.

5. The lithium nickel oxide cathode material according to claim 4, wherein, in the crystal structure of the lithium nickel oxide cathode material, Li that is surplus to the stoichiometric ratio of Ni occupies octahedral voids in a Ni layer in the layered structure and is randomly distributed in the octahedral voids.

6. The lithium nickel oxide cathode material according to claim 4, wherein by neutron diffraction detection, no Li₂NiO₃ unit with a space group of c/2m is detected in the crystal structure.

7. The lithium nickel oxide cathode material according to claim 4 the lithium nickel oxide cathode material is prepared by a preparation method comprising the following steps: (1) reacting a nickel source and a lithium source with oxygen in the presence of a molten salt additive to obtain a product comprising lithium nickel oxide; and (2) purifying the product comprising lithium nickel oxide to obtain a powder comprising lithium nickel oxide, and placing the powder in an oxygen environment to obtain the lithium nickel oxide cathode material.

8. A preparation method for the lithium nickel oxide cathode material according to claim 4, wherein the method comprises the following steps:
(1) reacting a nickel source and a lithium source with oxygen in the presence of a molten salt additive to obtain a product comprising lithium nickel oxide; and
(2) purifying the product comprising lithium nickel oxide to obtain a powder comprising lithium nickel oxide; and placing the powder in an oxygen environment to obtain the lithium nickel oxide cathode material.

9. The method according to claim 8, wherein the nickel source is selected from the group consisting of NiO, Ni(OH)₂, NiCO₃ and a combination thereof.

10. The method according to claim 8, wherein the lithium source is LiOH or LiOH·H₂O.

11. The method according to claim 8, wherein the molten salt additive is selected from the group consisting of Li₂SO₄, Na₂SO₄, K₂SO₄ and a combination thereof.

12. The method according to claim 8, wherein the molten salt additive is Li₂SO₄.

13. The method according to claim 8, wherein a molar ratio of the lithium source to the nickel source is 1.1-1.7:1; and/or, a molar ratio of the molten salt additive to the nickel source is 0.1-0.5:1.

14. The method according to claim 8, wherein molar ratio of the lithium source to the nickel source is 1.3-1.5:1; and/or, a molar ratio of the molten salt additive to the nickel source is 0.27-0.5:1.

15. The method according to claim 8, wherein in step (1), the reaction is carried out at a temperature of 550° C.-650° C.; and/or, in step (1), the reaction is carried out for 10-20 h; and/or, in step (2), the oxygen environment has a temperature of 450° C.-550° C.; and/or, in step (2), the powder is placed in an oxygen environment for 2-5 h.

16. The method according to claim 8, wherein in step (2), the purification comprises water washing and filtering; and/or, the method further comprises a step of crushing the product comprising lithium nickel oxide prior to the purification.

17. The method according to claim 8, wherein the method comprises the following steps:
(1) well mixing a nickel source, a lithium source and a molten salt additive to obtain a mixture, placing the mixture in a reactor, introducing oxygen into the reactor, and heating the mixture for reaction to obtain a product comprising lithium nickel oxide; and
(2) crushing the product comprising lithium nickel oxide, washing with water, filtering to obtain a powder comprising lithium nickel oxide, placing the powder in a reactor, introducing oxygen into the reactor, and heating to obtain the lithium nickel oxide cathode material.

18. The method according to claim 17, wherein in step (1), the oxygen is introduced at a rate of 0.1-0.5 L/min; and/or, in step (1), a heating rate is 2-10° C./min.

19. The method according to claim 17, therein in step (2), the oxygen is introduced at a rate of 0.1-0.5 L/min; and/or, in step (2), a heating rate is 2-10° C./min.

20. (canceled)

21. A lithium-ion battery, comprising a cathode, wherein, the cathode comprises the lithium nickel oxide cathode material according to claim 4.

22. The lithium-ion battery according to claim 21, wherein the first discharge energy density of the lithium-ion battery at a rate of 0.1 C is greater than or equal to 904 Wh/kg; and/or, after 100 charge-discharge cycles in a voltage range of 4.3-2.8 V at a rate of 1 C, the discharge specific capacity retention rate of the lithium-ion battery is greater than or equal to 92.3%.

23. The lithium nickel oxide cathode material according to claim 4, wherein, 0.03≤x≤0.06.

24. The lithium nickel oxide cathode material according to claim 4, wherein, 0.04≤x≤0.05.
